(19) United States
(12) Patent Application Publication
(10) Pub. No.: US 2004/0221456 A1
(43) Pub. Date: Nov. 11, 2004

(54) [CABLE STRIPPING AND BORING TOOL]

(76) Inventor: Roger M. Losinger, Liberty, PA (US)

Correspondence Address: JOHN J. ELNITSKI, JR., 225 A SNOWBIRD LANE, BELLEFONTE, PA, 16823, US

(21) Appl. No.: 10/249,764

(22) Filed: May 6, 2003

(51) Int. Cl. B26B 27/00

(52) U.S. Cl. 30/90.1; 30/90.2

(57) ABSTRACT

A tool having a main body, a cylinder shaped cable receiving area in the main body, at least one removal device and a boring tool component. The cylinder shaped cable receiving area is a round open diameter and includes a cable receiving opening which leads into the cable receiving area. The round open diameter of the cable receiving area reduces in size from a first open diameter to prevent flaring of an outer conductor of a cable. The boring tool component is mounted in the cable receiving area. A bore cavity in the boring tool component and including an open end which leads into the open diameter of the bore cavity.

### BACKGROUND OF INVENTION

The present invention generally relates to the striping of components of an electrical conducting cable. More specifically, the present invention relates to a tool for preparation of an electrical conducting cable to receive an electrical connector.

FIG. 1 shows an example of an electrical conducting cable 10 typically used in the cable television industry. The cable 10 shown includes an inner conductor, an outer conductor 12, dielectric material 14 and a protective jacket 16. The inner conductor includes a first conductor inner component 18 shown as a solid wire and a second inner conductor component 20 shown as a tube shape encircling the first conductor component 18. The dielectric material 14 is similar to the properties of Styrofoam. The dielectric material 14 is used to separate the first inner conductor component 18 from the second inner conductor component 20 and the second inner conductor component 20 from the outer conductor 12. FIG. 2 shows an end 22 of the cable 10 of FIG. 1 prepared to receive a electrical connector. FIG. 2 shows a good portion of the dielectric material 14 removed between the second inner conductor component 20 and the outer conductor 12. FIG. 2 also shows a portion of the outer conductor 12 removed and a portion of the jacket 16 removed.

Typically, a combination tool of blades and a boring tool are used to prepare the cable end 22. The boring tool is used to remove the dielectric material 14 and the blades are used to remove the outer conductor 12 and the jacket 16. The combination tool is usually rotated with a hand tool or power tool to prepare the cable end 22. Currently available combination tools to prepare the cable 10 as show in FIG. 2 have two distinct drawbacks. The first is that during use of such tools, the diameter of outer conductor 12 flares outward, thereby increasing the outer diameter of the outer conductor 12. This effect on the diameter of the outer conductor 12 causes a problem, whereby the outer conductor 12 is too large for the electrical connector. A second drawback is that the dielectric material 14 which remains about the second inner conductor component 20 creates a source of friction in the center of the boring tool during removal. This source of friction requires more force to turn the combination tool. Therefore, in the case of a hand tool, more hand force is required by the user to turn the combination tool. In the case of the power tool, more power is required to turn the combination tool, which would equate to further drain of a battery of a cordless tool. What is needed is a combination tool which addresses these drawbacks.

It is an object of the present invention to provide a combination tool for preparation of an electrical conducting cable to receive an electrical connector.

It is another object of the present invention to provide a combination tool which prevents deformation of components of an electrical conducting cable during preparation of the electrical conducting cable to receive an electrical connector.

### SUMMARY OF INVENTION

A tool having a main body, a cylinder shaped cable receiving area in the main body, at least one removal device and a boring tool component. The cylinder shaped cable receiving area is a round open diameter and includes a cable receiving opening which leads into the cable receiving area. The round open diameter of the cable receiving area reduces in size from a first open diameter to prevent flaring of an outer conductor of a cable. The boring tool component is mounted in the cable receiving area. A bore cavity in the boring tool component and including an open end which leads into the open diameter of the bore cavity.

### BRIEF DESCRIPTION OF DRAWINGS

FIG. 1 is a cable.

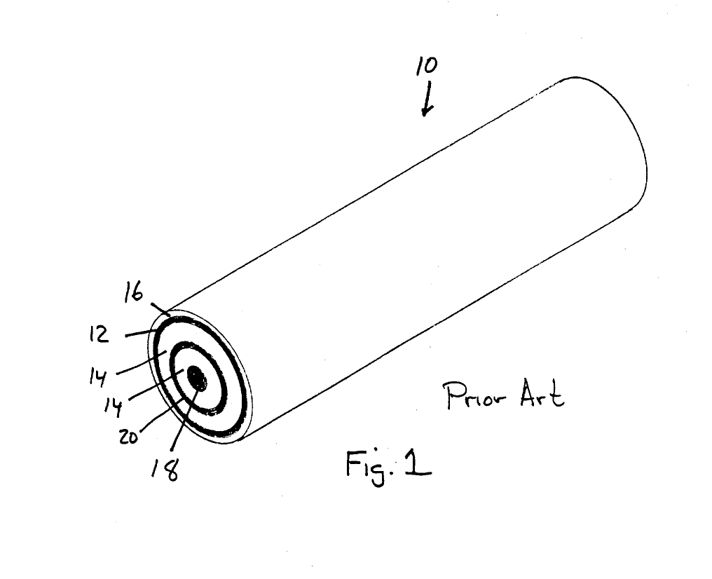

FIG. 2 is a cable with a prepared end.

FIG. 3 is an exploded view of a tool according to the present invention.

FIG. 4 is an exploded view of a tool according to the present invention.

FIG. 5 is a side view of a main body of the tool according to the present invention.

FIG. 6 is a perspective view of the main body of the tool according to the present invention.

FIG. 7 is a cross-sectional of the tool according to the present invention.

FIG. 8 is a cross-sectional of the tool according to the present invention.

### DETAILED DESCRIPTION

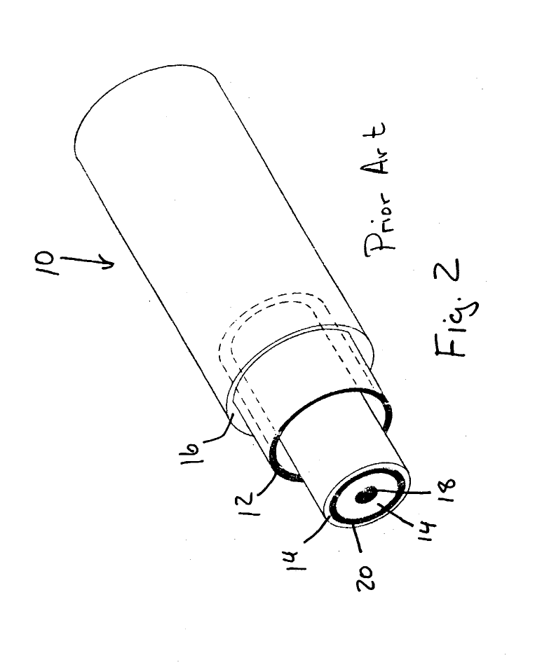

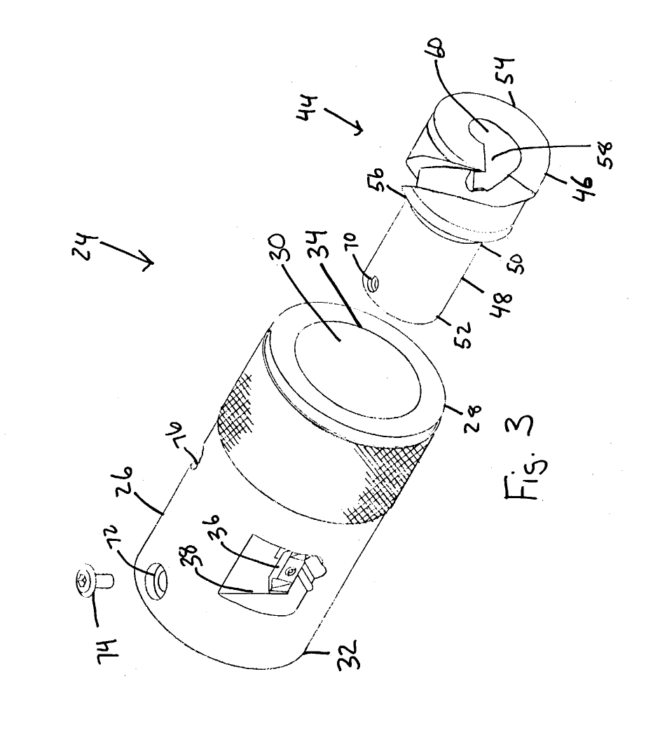

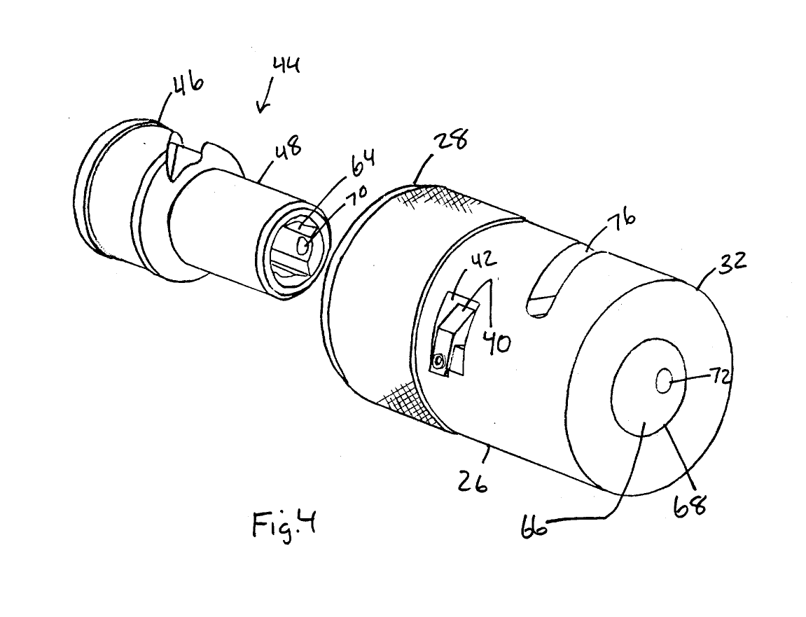

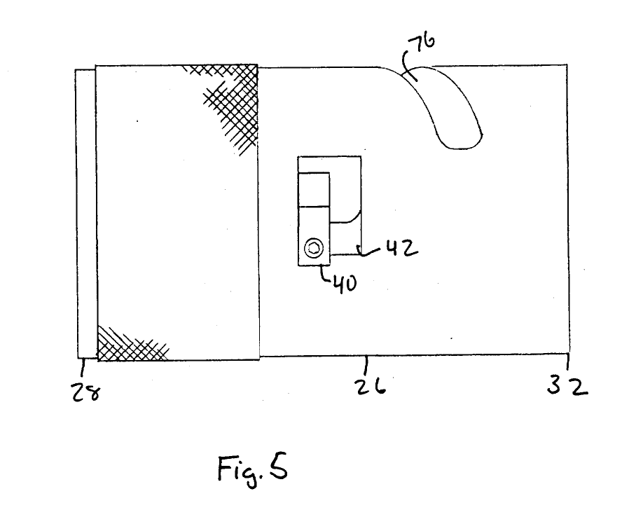

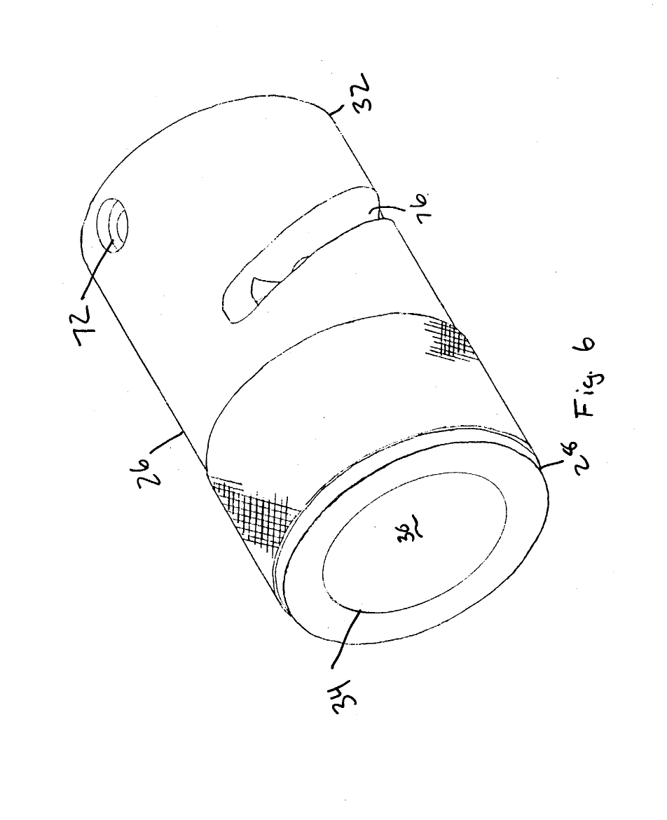

The present invention is a tool 24 for striping, cutting and boring of components of the cable 10 in order to prepare an end 22 of the cable 10, as shown in FIG. 2. The tool 24 is shown in FIGS. 3-8. As shown in FIGS. 3-8, the tool 24 includes a main body 26. The main body 26 includes a cable end 28, a cable receiving area 30 and an attachment end 32. The cable end 28 includes a cable receiving opening 34 which leads to the cable receiving area 30. The attachment end 32 includes a means to attach the tool to a hand or power tool in order to rotate the tool 24 about the end 22 of the cable 10. The hand or power tool is not shown, but an example of a hand tool is a socket ratchet and an example of a power tool is a cordless drill. FIG. 3 shows a conductor removing blade 36 mounted within a well 38 of the main body 26. The conductor removing blade 36 extends into the cable receiving area 30 from the well 38 of the main body 26. The conductor removal blade 36 cuts and removes an amount of the outer conductor 12 during rotation of the tool 24 about the cable 10. The material cut away from the outer conductor 12 is removed to the outside of the main body 26 due to the configuration of the conductor removal blade 36 and the well 38. The correct amount of the outer conductor 12 is removed based on the positioning of the conductor removal blade 36 along the main body 26 in relation to the cable receiving area 30. FIGS. 4-5, and 8 show a jacket removal blade 40 mounted within a well 42 of the main body 26. The jacket removal blade 40 extends into the cable receiving area 30 from the well 42 of the main body 26. The jacket removal blade 40 strips an amount of the jacket 16 during rotation of the tool 24 about the cable 10. The jacket 16 is removed to the outside of the main body 26 due to the configuration of the jacket removal blade 40 and the well 42. The correct amount of the jacket 16 is removed based on the positioning of the jacket removal blade 40 along the main body 26 in relation to the cable receiving area 30.

The tool includes a boring tool component 44, as shown in FIGS. 3-4 and 7-8. The boring tool component 44 fits into the cable receiving area 30 from the cable receiving opening 34 of the cable end 28, as shown in FIG. 3. The boring tool component 44 includes a cutting bore 46 extending from a shaft 48, which together form the boring tool component 44. The cutting bore 46 is configured to bore and remove the dielectric material 14 between the second inner conductor component 20 and the outer conductor 12. The shaft 48 includes a first end 50 and a second end 52. The cutting bore 46 includes a first end 54 and a second end 56, whereby the second end 56 of the cutting bore 46 extends from the first end 50 of the shaft 48. The shaft 48 and the cutting bore 46 include a continuous and centered bore cavity 58, which extends from an open end 60 at a first end 54 of cutting bore 46 into the first end 50 of the shaft 48. The bore cavity 58 ends as a flat face 62 in the shaft 48, near the second end 52 of the shaft 48. The flat face 62 acts as a stop to halt removal of any more material of the cable 10, when the end 22 of the cable 10 contacts the flat face 62. The second end 52 of the shaft 48 is shown with a socket cavity 64, as an example of the means to attach the hand or power tool to the tool. The socket cavity 64 is accessible from the second end 52 of the shaft 48 and is used for connection of the hand or power tool. The socket cavity 64 could be replaced with other fastening connection configurations to mate the tool with the hand or power tool.

The main body 26 is shown to include a shaft cavity 66 which extends from the cable receiving area 30 to the attachment end 32 of the main body 26. The shaft 48 of the boring tool component 44 fits into the shaft cavity 66. The attachment end 32 includes a tool access hole 68 to allow connection of the hand or power tool to the socket cavity 64 of the shaft 48, as shown in FIG. 4. FIG. 3 shows the tool 24 including a threaded set screw hole 70 in the shaft 48 near the second end 52 of the shaft 48. The main body 26 includes a set screw hole 72. A set screw 74 is inserted into the set screw hole 72 of the main body 26 and screwed into the threaded set screw hole 70 of the shaft 48 to secure the shaft 48 and hence the boring tool component 44 in the main body 26. Therefore, as the hand or power tool rotates the shaft 48 due to the connection to the socket cavity 64, the main body 26 with both the conductor removing blade 36 and the jacket removal blade 40 rotates to remove the outer conductor 12 and jacket 16 of the cable 10. The main body 26 also includes a dielectric material removal slot 76 which follows the shape of the cutting bore 46 and acts as an exit for the dielectric material 14 removed from between the second inner conductor component 20 and the outer conductor 12, as shown in FIGS. 4-8.

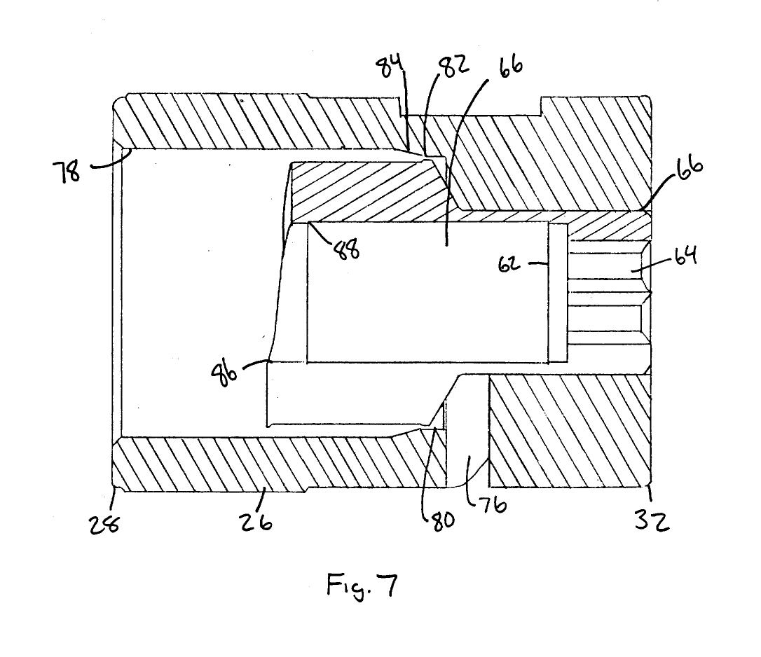

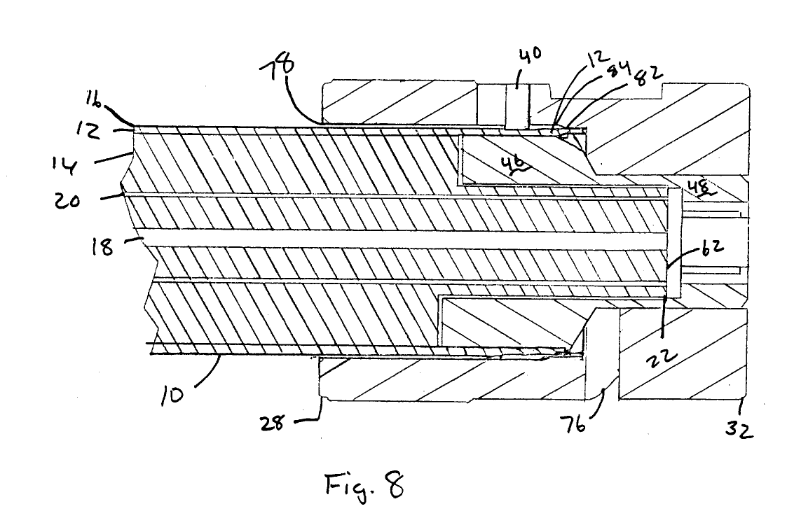

FIGS. 7-8 show the features which make the tool 24 of the present invention an improvement over currently available tools. A first feature is the shape of the cable receiving area 30 inside the main body 26. At the cable receiving opening 34 and for most of the cable receiving area 30, a first diameter 78 of the cable receiving area 30 is slightly larger than the diameter of the cable 10 including the jacket 16. This allows the cable 10 to be inserted into the tool 24 to be prepared to receive the electrical connector. Near a second end 80 of the cable receiving area 30, the diameter of the cable receiving area 30 reduces from the first diameter 78 to a second diameter 82 at a gradual rate. Whereby, the second diameter 82 is slightly larger than the diameter of the outer conductor 12. This reduction in diameter is in an area 84 where the jacket 16 of the cable 10 has been removed, while the cable 10 is in the tool 24. The reduction in diameter prevents outward flaring of the outer conductor 12, so that the outer conductor 12 fits into the electrical connector. Also to prevent flaring of the outer conductor 12, the conductor removing blade 36 and the well 38 of the main body 26 associated with the conductor removing blade 36 are positioned along the main body 26 in the area 84 of reduction from the first diameter 78 to the second diameter 82. This reduction of diameter channels the outer conductor 12 into a cutting edge of the conductor removing blade 36, which also aids in the prevention of flaring of the outer conductor 12.

Another feature is the shape of the bore cavity 58 of the boring tool component 44. A first diameter 86 of the bore cavity 58 at the open end 60 of the first end 54 of cutting bore 46 is the diameter of the remaining dielectric material 14 about the second inner conductor component 20, as the cutting bore 46 removes dielectric material 14. Further into the bore cavity 58, the diameter of the bore cavity 58 increases to a second diameter 88. Whereby, the second diameter 88 is a size larger than the diameter of the remaining dielectric material 44. Having the initial diameter of the first diameter 86 aids in centering and maintaining the position of the cable 10, as the cable 10 is prepared by the tool 24. Increasing the diameter further into the bore cavity 58 prevents the remaining dielectric material 14 about the second inner conductor component 20 from creating a source of friction in the center of the boring tool component 44 between the boring tool component 44 and the remaining dielectric material 14 during preparation of the cable 10. The length along the bore cavity 58 in which the first diameter 86 is maintained should be just enough to keep the cable 10 centered during preparation of the cable 10.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

1. A tool, for removing material between an inner conductor and an outer conductor from an electrical conducting cable and removing an outer layer covering the outer conductor, comprising:
a main body;
a cylinder shaped cable receiving area of a round open diameter within said main body to receive the cable, said cable receiving area including a cable receiving opening which leads into said cable receiving area to allow insertion of the cable into said tool, said cable receiving opening of a first open diameter of said cable receiving area and being at least a size to allow insertion of the cable;
at least one removal device attached to said main body to remove the outer layer of the cable;
a boring tool component mounted in said cable receiving area to bore and remove material between the inner conductor and the outer conductor of the cable;
a bore cavity centered in said boring tool component and having an open diameter to receive remaining components of the cable, said bore cavity including an open end which leads into said open diameter of said bore cavity to receive the remaining components of the cable, said open end of a first open diameter of said bore cavity and being a size of the remaining components of the cable to center the cable in the tool.

2. The tool of claim 1, wherein said round open diameter of said cable receiving area reduces in size from said first open diameter to prevent flaring of the outer conductor of the cable.

3. The tool of claim 2, wherein said round open diameter of said cable receiving area reduces in size from said first open diameter in an area of said cable receiving area that the cable enters where the outer layer has been removed.

4. The tool of claim 2, further including at least one outer conductor removal device attached to said main body and extending into said cable receiving area to remove a portion of the outer conductor of the cable.

5. The tool of claim 3, further including at least one outer conductor removal device attached to said main body and extending into said cable receiving area to remove a portion of the outer conductor of the cable.

6. The tool of claim 5, wherein said at least one outer conductor removal device is positioned in said area of said cable receiving area that the cable enters where the outer layer has been removed.

7. The tool of claim 1, wherein said open diameter of said bore cavity increases in size from said first open diameter of said bore cavity to prevent the remaining components of the cable from creating a source of friction with said bore cavity.

8. The tool of claim 2, wherein said open diameter of said bore cavity increases in size from said first open diameter of said bore cavity to prevent the remaining components of the cable from creating a source of friction with said bore cavity.

9. The tool of claim 3, wherein said open diameter of said bore cavity increases in size from said first open diameter of said bore cavity to prevent the remaining components of the cable from creating a source of friction with said bore cavity.

10. The tool of claim 4, wherein said open diameter of said bore cavity increases in size from said first open diameter of said bore cavity to prevent the remaining components of the cable from creating a source of friction with said bore cavity.

11. The tool of claim 5, wherein said open diameter of said bore cavity increases in size from said first open diameter of said bore cavity to prevent the remaining components of the cable from creating a source of friction with said bore cavity.

12. The tool of claim 6, wherein said open diameter of said bore cavity increases in size from said first open diameter of said bore cavity to prevent the remaining components of the cable from creating a source of friction with said bore cavity.
